(19) United States
(12) Patent Application Publication
(10) Pub. No.: US 2026/0113662 A1
(43) Pub. Date: Apr. 23, 2026

(54) SEAMLESS ROAMING IN WIRELESS NETWORK

(71) Applicant: TP-Link Systems Inc., IRVINE, CA (US)

(72) Inventors: Yunpeng YANG, Shenzhen (CN); Junbin CHEN, Chengdu (CN); Renfang ZHOU, Shenzhen (CN)

(73) Assignee: TP-Link Systems Inc., IRVINE, CA (US)

(21) Appl. No.: 18/922,074

(22) Filed: Oct. 21, 2024

(51) Int. Cl. H04W 28/14

(52) U.S. Cl. CPC H04W 28/14

(57) ABSTRACT

A first access point (AP) device including one or more processors; a memory coupled to at least one of the processors; and a set of computer program instructions stored in the memory, which, when executed by at least one of the processors, cause the first AP device to perform operations of: receiving, from a second AP device to which a client device is being connected, a first context of the connection between the second AP device and the client device, wherein the first context indicates a next data frame and an amount of buffered data frames to be transmitted by the second AP device; and transmitting, to the client device, data frames starting from a data frame with a first sequence number (SN) based on a SN of the next data frame and the amount of buffered data frames.

### TECHNICAL FIELD

The present disclosure relates to wireless communication, and in particular, to access point (AP) devices, methods, system and computer program products for facilitating seamless roaming in a wireless network.

### BACKGROUND

Wireless local area network (wireless local area network, WLAN) roaming or Wi-Fi roaming refers to a process in which a wireless terminal, a station (station, STA) or a client moves from an access point (access point, AP) to another AP. In a WLAN roaming or Wi-Fi roaming process, an IP address obtained by a client at an initial stage of connecting to the network does not change, so that a service is not interrupted.

When the STA roams from one AP to another AP, the STA first disconnects from the original AP, and then is associated with a new AP. Before establishing an association with the new AP, service data transmission cannot be performed between the STA and the AP connected to the network, thereby causing transmission delay and data packet loss. Therefore, there is a need for enhancement on the Wi-Fi roaming process.

### SUMMARY

In view of the above problems, the present disclosure provides access point (AP) devices, methods, system, and computer program products for facilitating seamless roaming in a wireless network.

In accordance with one embodiment of the present disclosure, there is provided an access point (AP) device. The AP device may be a first AP device, which comprises one or more processors; a memory coupled to at least one of the processors; and a set of computer program instructions stored in the memory. When executed by at least one of the processors, the set of computer program instructions may cause the first AP device to perform the following operations: receiving, from a second AP device to which a client device is being connected, a first context of the connection between the second AP device and the client device, wherein the first context indicates a next data frame and an amount of buffered data frames to be transmitted by the second AP device; and transmitting, to the client device, data frames starting from a data frame with a first sequence number (SN) based on a SN of the next data frame and the amount of buffered data frames.

In accordance with another embodiment of the present disclosure, there is provided an access point (AP) device. The AP device may be a first AP device to which a client device is being connected. The first AP device comprises one or more processors; a memory coupled to at least one of the processors; and a set of computer program instructions stored in the memory. When executed by at least one of the processors, the set of computer program instructions may cause the first AP device to perform the following operations: transmitting, to a second AP device, a first context of the connection between the first AP device and the client device, wherein the first context indicates a next data frame and an amount of buffered data frames to be transmitted by the first AP device; and transmitting, to the client device, the buffered data frames.

In accordance with a further embodiment of the present disclosure, there is provided a method for wireless communication implemented at an access point (AP) device, which is a first AP device. The method may comprise receiving, from a second AP device to which a client device is being connected, a first context of the connection between the second AP device and the client device, wherein the first context indicates a next data frame and an amount of buffered data frames to be transmitted by the second AP device; and transmitting, to the client device, data frames starting from a data frame with a first sequence number (SN) based on a SN of the next data frame and the amount of buffered data frames.

In accordance with yet another embodiment of the present disclosure, there is provided a method for wireless communication implemented at an access point (AP) device, which is a first AP device to which a client device is being connected. The method may comprise transmitting, to a second AP device, a first context of the connection between the first AP device and the client device, wherein the first context indicates a next data frame and an amount of buffered data frames to be transmitted by the first AP device; and transmitting, to the client device, the buffered data frames.

In accordance with still another embodiment of the present disclosure, there is provided a computer program product for wireless communication. The computer program product may comprise a non-transitory computer readable storage medium having program instructions embodied therewith. The program instructions are executable by a processor of an access point (AP) device, which is a first AP device, to cause the processor to receive, from a second AP device to which a client device is being connected, a first context of the connection between the second AP device and the client device, wherein the first context indicates a next data frame and an amount of buffered data frames to be transmitted by the second AP device; and transmit, to the client device, data frames starting from a data frame with a first sequence number (SN) based on a SN of the next data frame and the amount of buffered data frames.

In accordance with a yet further embodiment of the present disclosure, there is provided a computer program product for wireless communication. The computer program product may comprise a non-transitory computer readable storage medium having program instructions embodied therewith. The program instructions are executable by a processor of an access point (AP) device, which is a first AP device to which a client device is being connected, to cause the processor to transmit, to a second AP device, a first context of the connection between the first AP device and the client device, wherein the first context indicates a next data frame and an amount of buffered data frames to be transmitted by the first AP device; and transmit, to the client device, the buffered data frames.

In accordance with another embodiment of the present disclosure, there is provided a wireless communication system comprising at least a first access point (AP) device to which a client device is being connected and a second AP device. The first AP device may be configured to perform the following operations: transmitting, to a second AP device, a first context of the connection between the first AP device and the client device, wherein the first context indicates a next data frame and an amount of buffered data frames to be transmitted by the first AP device; and transmitting, to the client device, the buffered data frames. The second AP device may be configured to perform the following operations: receiving, from a second AP device to which a client device is being connected, a first context of the connection between the first AP device and the client device, wherein the first context indicates a next data frame and an amount of buffered data frames to be transmitted by the second AP device; and transmitting, to the client device, data frames starting from a data frame with a first sequence number (SN) based on a SN of the next data frame and the amount of buffered data frames.

In accordance with the embodiments of the present disclosure, an enhanced roaming mechanism for wireless communication can be realized by means of context transfer.

### BRIEF DESCRIPTION OF THE DRAWINGS

The above and other objects, features and advantages of the present disclosure will become more apparent by describing embodiments of the present disclosure in more detail in conjunction with accompanying drawings. The drawings are used to provide a further understanding of the embodiments of the present disclosure and constitute a part of the specification. The drawings together with the embodiments of the present disclosure are used to explain the present disclosure, but do not constitute a limitation on the present disclosure. In the drawings, unless otherwise explicitly indicated, the same reference numerals refer to the same components, steps, or elements.

FIG. 1 illustrates an exemplary architecture 100 of a wireless communication system in accordance with an embodiment of the present disclosure;

FIG. 2 illustrates an exemplary multi-link reference model 200 for a Multi-Link (ML) device in accordance with an embodiment of the present disclosure;

FIG. 3 illustrates an exemplary multi-link communication arrangement 300 in accordance with an embodiment of the present disclosure;

FIG. 4 shows an exemplary schematic diagram illustrating a roaming process 400 in accordance with an embodiment of the present disclosure;

FIG. 5 shows an exemplary schematic diagram illustrating an enhanced roaming process 500 in accordance with an embodiment of the present disclosure;

FIG. 6 shows an exemplary schematic diagram illustrating a further enhanced roaming process 600 in accordance with an embodiment of the present disclosure;

FIG. 7 shows a flowchart of a computer-implemented method 700 for wireless communication implemented at an access point (AP) device in accordance with an embodiment of the present disclosure;

FIG. 8 shows a flowchart of a computer-implemented method 800 for wireless communication implemented at an access point (AP) device to which a client device is being connected in accordance with an embodiment of the present disclosure;

FIG. 9 is an exemplary block diagram illustrating a computing device in accordance with some embodiments of the present disclosure.

One skilled in the art will appreciate that elements in the figures are illustrated for simplicity and clarity and have not necessarily been depicted to scale. For example, the dimensions of some of the elements in the illustrations, block diagrams or flowcharts may be exaggerated in respect to other elements to help an accurate understanding of the present embodiments.

### DETAILED DESCRIPTION

The following detailed description refers to the accompanying drawings. While several illustrative embodiments are described herein, modifications, adaptations and other implementations are possible. For example, substitutions, additions, or modifications may be made to the components and steps illustrated in the drawings, and the illustrative methods described herein may be modified by substituting, reordering, removing, or adding steps to the disclosed methods. Accordingly, the following detailed description is not limited to the disclosed embodiments and examples. Instead, the proper scope of the invention is defined by the appended claims.

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Discussions herein utilizing terms such as, for example, “receiving”, “transmitting”, “reassociating”, “transferring”, “requesting”, “forwarding”, “authorizing”, “establishing”, “enabling”, “sending” or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner. Likewise, articles such as “a”, “an” or “the” do not represent a quantity limit, but represent an existence of at least one. Words such as “connect” and “link” are not limited to physical or mechanical connections, but may include electrical connections, whether direct or indirect.

In addition, technical features involved in different embodiments of the present disclosure described below may be combined with each other as long as no conflicts occurs therebetween.

In the present disclosure, an AP, which may be interchangeably referred to as a wireless access point (WAP), is a communication device that can communicate with a non-AP device (e.g., a station (STA) or client device) in a WLAN and that allows the non-AP to connect to a wired network. The AP usually connects to a router (via a wired network) as a standalone device, but it can also be integrated with or employed in the router. Likewise, in the present disclosure, a non-AP (e.g., a client device or station, which is interchangeably referred to as a STA) is a communication device that can communicate with an AP to obtain various communication services such as voice, video, packet data, messaging, broadcast, etc. The STA can be any device that contains an IEEE 820.11-conformant media access control (MAC) and physical layer (PHY) interface to the wireless medium (WM). For example, a STA may be a laptop, a desktop personal computer (PC), a personal digital assistant (PDA), an access point or a Wi-Fi phone in a WLAN environment. The STA may be fixed or mobile. In the WLAN environment, the terms “STA”, “client device”, “wireless client”, “user” and “user device” are often used interchangeably.

In the present disclosure, a STA in a WLAN may work as an AP at a different occasion, and vice versa. This is because communication devices in the context of IEEE 820.11 (Wi-Fi) technologies may include both STA hardware components and AP hardware components. In this manner, the communication devices may switch between a STA mode and an AP mode, based on actual WLAN conditions and/or requirements. In various embodiments below, a non-AP STA may refer to a STA in a WLAN that is not implemented as an AP.

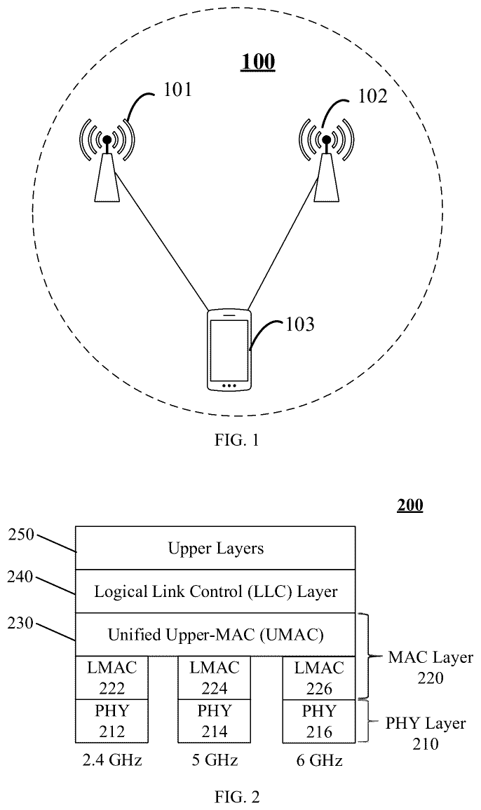

FIG. 1 illustrates an exemplary architecture 100 of a wireless communication system according to an embodiment of the present disclosure. As shown in FIG. 1, the wireless communication system includes multiple AP devices (for example, an AP device 101 and an AP device 102 in FIG. 1) and one client device 103, and can be employed in IEEE 802.11 WLAN networks. The AP device is a device that provides a service for the client device, and the client device may communicate with the AP device. The quantity of AP devices and the quantity of client devices in FIG. 1 are merely an example.

As previously discussed, the AP is capable of establishing WLAN communication with the client device 103 enabling the client devices to connect to a wired network. This permits the client device 103 to access a variety of communication services from the Internet, including voice, video, packet data, messaging, and broadcast, among others. The client device in embodiments of the present disclosure has a wireless transceiver function, may support the 802.11 series protocols, and may communicate with the AP device or another client device. After the client device 103 successfully associates with the AP through the 802.11 association procedure, data transfer between the client device 103 and the AP can commence. This allows the client device 103 to transmit and receive data packets to and from the network through the AP. The client device is any user communication device that allows a user to communicate with an AP and then communicate with a WLAN. For example, the client device may be user equipment that can be connected to a network, including but not limited to, for example, a smartphone, a tablet computer, a desktop computer, a laptop computer, a notebook computer, an ultra-mobile personal computer, a handheld computer, a netbook, a personal digital assistant, and other internet-capable devices, may be an internet of things node in the internet of things, or may be a vehicle-mounted communication apparatus in the internet of vehicles. The AP device in embodiments of this application is an apparatus that serves the client device, and may support the 802.11 series protocols. For example, the AP device may be a communication entity such as a communication server, a router, a switch, or a bridge, or the AP device may include various forms of macro base stations, micro base stations, relay stations, and the like. Certainly, the AP device may alternatively be chips and processing systems in the various forms of devices, to implement the method and the function in embodiments of the present disclosure. Herein, the term “data packet” may refer to “data frame” and the like.

The architecture presented in FIG. 1 is only illustrative and does not impose any limitations on any embodiment of the present disclosure. Multiple APs in the WLAN network can serve specific sets of associated client devices, and depending on application requirements and overall network constraints, the number of client devices in each serving set can be more than one client device as depicted.

In IEEE 802.11be standard, the Multi-Link Operation (MLO) technology is introduced, in which a single device, namely a Multi-Link (ML) device (MLD), implements a ML logical entity made of a plurality of stations. The stations can use 802.11 protocols to communicate with stations of another MLD over respective communication links, thereby establishing a multilink communication session to exchange data units (e.g., MPDUs). Therefore, one MLD can transmit messages over multiple links simultaneously to improve throughput.

Herein, “multilink device”, “ML device” (MLD), “multilink logical entity”, “ML logical entity” (MLE), “multilink set” and “ML set” may be used interchangeably.

A multi-link device is an apparatus having a wireless communication function. The apparatus may be an entire device, or may be a chip, a processing system, or the like installed in an entire device. A device in which these chips or processing systems are installed may be controlled by these chips or processing systems, to implement the method and a function in embodiments of the present disclosure. In some embodiments of the present disclosure, the AP device (for example, the AP devices 101, 102 depicted in FIG. 1) may be AP ML device, and the client device (for example, the client device 103 depicted in FIG. 1) may be non-AP ML device. The multi-link device may implement wireless communication in compliance with the IEEE 802.11 series protocols. For example, the multi-link device may be a station in compliance with the extremely high throughput rate, based on IEEE 802.11be, or compatible with IEEE 802.11be, to implement communication with other devices.

FIG. 2 illustrates an exemplary multi-link reference model 200 for a Multi-Link (ML) device in accordance with an embodiment of the present disclosure.

The ML device illustrated in FIG. 2 may be an AP ML device or a non-AP ML device, and may be an originator ML device (i.e., device transmitting data) or a recipient ML device (i.e., device receiving data from the originator ML device).

As shown in FIG. 2, the ML device comprises a PHY layer 210, a MAC layer 220, a logical Link Control (LLC) layer 240 and upper layers 250. Upper layers 250 may include applications that generate traffic data for transmission by the MAC and PHY layers over the multiple links or that use traffic data received by the MAC and PHY layers over the multiple links. The PHY layer 210 comprises multiple PHY blocks 212, 214, 216 dedicated for respective multiple links. The MAC layer 220 also comprises multiple blocks 222, 224, 226 for respective multiple links.

The IEEE 802.11be standard focuses on 802.11 physical layer (physical layer, PHY) and MAC layer parts in a multi-link device. As shown in FIG. 2, the MAC layer 220 further comprises a Unified Upper MAC (UMAC) 230. UMAC 230 is responsible for link-agnostic MAC procedures such as fragmentation, sequence number assignments, MPDU encryption/decryption, duplication detection, dynamic link switching, block ack scoreboarding, etc. It offers a UMAC interface with the link-specific blocks 222, 224, 226 (forming lower MAC sublayers, therefore referred to as LMAC) and provides a UMAC Service Access Point (SAP) to the LLC layer 240 and the upper layers 250. That is, multiple STAs affiliated to the multi-link device share one high MAC (high MAC) layer, but a low MAC (low MAC) layer and a PHY layer are independent of each other. It may be understood that the multiple STAs affiliated to the multi-link device may alternatively be independent of each other at a low MAC layer and a PHY layer, and also be independent of each other at a high MAC layer.

Although FIG. 2 shows three LMAC and PHY blocks, another number of blocks may be contemplated depending on the number of links the ML device can manage. As an example, LMAC block 222 may be associated with, for example, a link of 2.4 GHz via PHY block 212, LMAC layer 224 may be associated with, for example, a link of 5 GHz via PHY block 214, and LMAC layer 226 may be associated with, for example, a link of 6 GHz via PHY block 216. That is, each link may have an associated LMAC block 222/224/226 that performs link-specific features, such as channel access.

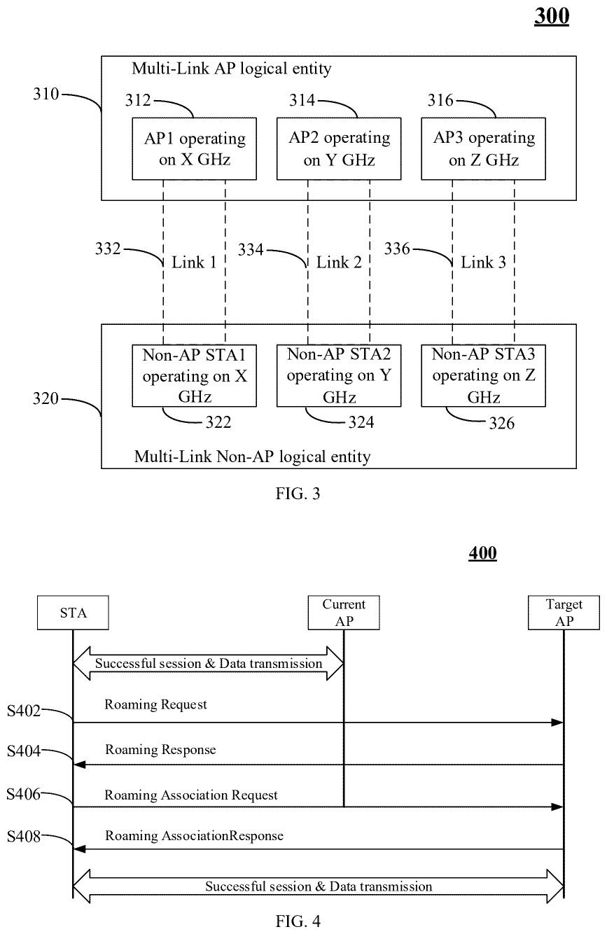

FIG. 3 illustrates an exemplary multi-link communication arrangement 300 in accordance with an embodiment of the present disclosure. As shown in FIG. 3, a multi-link AP logical entity 310, e.g., an AP MLD, may include a plurality of affiliated AP STAs, e.g., including an AP STA 312, an AP STA 314, and an AP STA 316. Furthermore, as shown in FIG. 3, a multi-link non-AP logical entity 320, e.g., a non-AP MLD, may include a plurality of affiliated non-AP STAs, e.g., including a non-AP STA 322, a non-AP STA 324, and a non-AP STA 326. The multi-link AP logical entity 310 and the multi-link non-AP logical entity 320 may be configured to form, setup and/or communicate over a plurality of communication channels or links, for example, including a link 332 (shown as link 1) between STA 312 and STA 322, a link 334 (shown as link 2) between STA 314 and STA 324, and/or a link 336 (shown as link 3) between STA 316 and STA 326. The terminology “link” is used to better align with the IEEE 802.11 standards. The AP STAs 312, 314, 316 and the non-AP STAs 322, 324, 326 operate in accordance with one or more of the IEEE 802.11 standards and other wireless communication standards.

The AP STAs 312, 314, 316 (and thus the corresponding non-AP STAs 322, 324, 326) may operate in frequency bands (shown as X, Y, Z) that are different one from the other as shown in the exemplary embodiment of FIG. 3. For instance, X=2.4 GHz, Y=5 GHz, and Z=6 GHz. Alternatively, two or more of the stations may use the same frequency band; for instance, y=z=6 GHz.

Although FIG. 3 shows an AP MLD and a non-AP MLD establishing a ML communication session, two non-AP MLDs may also establish such a ML communication session. Likewise, although MLDs made of three stations are shown in FIG. 3, MLDs with another number of affiliated stations may be contemplated with the same teachings. In addition, MLDs may have different numbers of affiliated stations.

To reduce traffic interruption time when a client device transition between APs in traditional Wi-Fi roaming mechanisms, Fast Basic Service Set (BSS) Transition (FT) roaming mechanism was originally proposed in IEEE 802.11r Amendment with two approaches: Over-the-Air and Over-the-DS. However, the existing roaming mechanisms, including the FT roaming mechanisms, still require further improvements, as described hereinafter.

FIG. 4 shows an exemplary schematic diagram illustrating a roaming process in accordance with an embodiment of the present disclosure. As shown in FIG. 4, the STA is initially associated with an AP device, i.e., the current AP in FIG. 4, which may also be referred to as Home AP (HAP), and it proceeds successful session and data transmission with the current AP, so as to communication with the network.

When the STA determines that it must transition to another AP device, i.e., the target AP in FIG. 4, which may also be referred to as Foreign AP (FAP), due to various reasons, it will transmit a roaming request directly to the target AP, as shown at step S402 of FIG. 4, i.e., in the manner of Over-the-Air. Along with the roaming request, a security key PMK-R1 is sent to the target AP. After receiving the roaming request, the target AP may generate and install a corresponding security key PTK according to information contained therein and the security key PMK-R1, and initiate a reassociation timer simultaneously. Then, as shown at step S404 of FIG. 4, the target AP transmits a roaming response to the STA.

After receiving the roaming response, the STA generates and installs the security key PTK. Then, the STA transmits a roaming association request to the target AP, as shown at step S406 of FIG. 4.

After receiving the roaming association request, the target AP turns off the reassociation timer and transmits a roaming association response to the STA, as shown at step S408 of FIG. 4. After receiving the roaming association response, the STA completes the roaming, and thus can proceed successful session and data transmission with the target AP, so as to communication with the network.

Similar as the Over-the-Air roaming process shown in FIG. 4, the Over-the-DS roaming process (not shown) also include the steps S406-S408 of FIG. 4, the differences are the steps S402-S404. Specifically, in the Over-the-DS roaming process, the STA transmits the roaming request to the current AP, which relays the roaming request to the target AP, and similarly, the target AP transmits the roaming response to the current AP, which relays the roaming response to the STA.

When a client device (for example, the STA in FIG. 4) is associated with an AP device (for example, the current AP in FIG. 4), for the downlink (DL) data transmission from the AP device to the client device, data packets are firstly buffered in the AP device, and then the data packets buffered in the AP device are transmitted to the client device. During the roaming process, when the STA transmits the roaming request to the target AP, the DL data transmission may be interrupted, and some data packets buffered in the current AP may be not transmitted to the STA. The new AP device (for example, the target AP in FIG. 4) can transmits data packets to the STA only after establishing association with the STA, i.e., the STA achieve reassociation with the new AP. It can be seen that during the roaming process, on the one hand, the DL service data transmission to the STA would be interrupted, causing data transmission delay; on the other hand, when the target AP transmits data packets associated with the STA, it may transmit data packets buffered therein from the upper layers, for example, the distributed system, while the data packets that are buffered in the current AP and are not transmitted to the STA before roaming will loss.

Those skilled in the art would appreciate that transmission delay and packet loss issues exist in the traditional roaming mechanisms, including but not limited to the FT roaming mechanism, many other roaming mechanisms conforming to IEEE 802.11 protocols, among others.

In order to mitigate the transmission delay and packet loss issues during roaming, the present disclosure proposes an enhancement for the current roaming mechanisms, which addresses the transmission delay and packet loss issues by context transfer. Specifically, a target AP, with which a STA intends to be associated, acquires context of the connection between the STA and a current AP, with which the STA is being associated, and the context including information about how many data packets that are buffered in the current AP and are going to transmit to the STA and a next data packet that is going to transmit to the STA. After acquiring the context, the current AP may still transmit data packets to the STA, reducing DL transmission delay and mitigating the packet loss issue. Moreover, after the reassociation between the STA and the target AP, the target AP may transmit to the STA data packets with right sequence numbers, i.e., not transmitting duplicated data packets that have been transmitted by the current AP, thereby mitigating the packet loss issue.

FIG. 5 shows an exemplary schematic diagram illustrating an enhanced roaming process 500 in accordance with an embodiment of the present disclosure.

As shown in FIG. 5, there are a non-AP MLD, a current AP MLD, a target AP MLD, and a distributed system (DS). The non-AP MLD, the current AP MLD and the target AP MLD may apply a multi-link reference model substantially similar as the multi-link reference model 200 described with reference to FIG. 2, and the non-AP MLD may be communication connected to any of the current AP MLD and the target AP MLD by a multi-link communication arrangement substantially similar as the multi-link communication arrangement 300 described with reference to FIG. 3.

Like the roaming process described with reference to FIG. 4, the non-AP MLD, which is similar as the STA in FIG. 4, is initially associated with (for example, wirelessly connected to) the current AP MLD, which is similar as the current AP in FIG. 4.

After the non-AP MLD and the current AP MLD learn the link connection status therebetween according to the 802.11k protocol, it may be determined that the non-AP MLD need to transition to another AP device, for example, the target AP MLD in FIG. 5. In some embodiments of the present disclosure, based on the link connection status between the non-AP MLD and the current AP MLD, the current AP MLD may transmit a BSS Transition Management (BTM) message to trigger the non-AP MLD to roam, for example, informing the non-AP MLD which AP MLD the non-AP MLD roams to. Additionally or alternatively, the non-AP MLD take the initiative to choose an AP MLD to which it roams.

After determining that the non-AP MLD is going to transition to the target AP MLD, the non-AP MLD may transmit, to the target AP MLD, a roaming association request frame to request associate with the target AP MLD, as shown at step S506 of FIG. 5. In some embodiments of the present disclosure, the non-AP MLD would stop transmitting uplink (UL) data packets at the same time of transmitting the roaming association request frame.

After receiving the roaming association request frame, the target AP MLD may start roaming preprocessing. After a period of processing, the target AP MLD may transmit, to the non-AP MLD, a roaming association response frame, as shown at step S508 of FIG. 5. It should be noted that steps S506-S508 of FIG. 5 may be similar as steps S406-S408 of FIG. 4.

Different from the roaming process described with reference to FIG. 4, in the enhanced roaming process of FIG. 5, after receiving the roaming association request frame, the target AP MLD may transmit, to the current AP MLD, a context transfer request frame, as shown at step S510 of FIG. 5, to request the context of the connection established between the non-AP MLD and the current AP MLD, including data and statue information, for example, block acknowledgement (BA) process data, power saving information, priorities of the data steam, among others. Meanwhile, the target AP MLD may transmit a mapping request, for example a DS-STA-Notify. request primitive carrying mapping information between the target AP MLD and the non-AP MLD, to the distributed system, as shown at step S511 of FIG. 5. The DS-STA-Notify. request primitive is used for notifying of STA-AP mapping information of the distributed system. This is because each non-AP MLD can be associated with only one AP MLD. The distributed system must know which AP MLD serves the non-AP MLD, and then deliver a data packet whose destination address is a MAC address of the non-AP MLD to the corresponding AP MLD. That is, the distributed system may deliver data packets whose destination address is a MAC address of the non-AP MLD to the target AP MLD after it knows the target AP MLD serves the non-AP MLD.

In some embodiments of the present disclosure, the DS-STA-Notify. request primitive may carry the SAP MAC address of the non-AP MLD and an update type (Update Type). The update type may include three types: ADD (add), MOVE (move), and DELETE (delete). ADD is used in DS-STA-Notify. request primitive sent by the AP MLD when the non-AP MLD associates with a specific AP MLD for the first time. DELETE is used in DS-STA-Notify. request primitive sent by the AP MLD when the non-AP MLD disassociates from a specific AP MLD for the first time. MOVE is used in DS-STA-Notify, request primitive sent by the AP MLD when the non-AP MLD switches from a specific AP MLD to a new AP MLD.

It can be seen that, in the embodiment of FIG. 5, the update type carried in the DS-STA-Notify. request primitive sent by the target AP MLD is MOVE. When a client is the non-AP MLD, the MAC address in the DS-STA-Notify. request primitive sent by the target AP MLD is the SAP MAC address of the non-AP MLD.

After receiving the context transfer request frame, the current AP MLD may transmit, to the target AP MLD, a context transfer response frame, as shown at step S512 of FIG. 5. Alternatively, the target AP MLD may not transmit a context transfer request frame to the current AP MLD, the current AP MLD may acquire the roaming association request from the non-AP MLD, the target AP MLD, or the DS, and then transmit the context transfer response frame to the target AP MLD after a predetermined period of time, for example, the transmission of the context transfer response frame may be triggered by a timer.

The context transfer response frame may include the context of the connection established between the non-AP MLD and the current AP MLD, including but not limited to, Non-AP MLD MAC Address, DL BA context, UL BA context, and so on. In some embodiments, the DL BA context may include a traffic identification (TID) field, a next sequence number (SN) field, a buffer SN field, among others. In some embodiments, the next SN field may indicate the SN of the next data frame or packet to be transmitted by the current AP MLD, i.e., the next SN. In some embodiments, the buffer SN field may indicate an amount of data frames or packets to be transmitted by the current AP MLD. In some embodiments, the UL BA context may include a TID field, a scoreboard field, among others.

In order to prevent DL data from being suspended during roaming, it is necessary to reserve some buffered data in the current AP MLD in the transmitted DL BA context and add the buffer SN field to ensure that DL data can continue to be transmitted by the current AP MLD during roaming, as shown at step S514 of FIG. 5. If the buffer SN field is missing, the current AP MLD and the target AP MLD may transmit data packet to the non-AP MLD with the same SN, causing duplicated transmission. For example, if the current AP MLD transmits a data packet with a SN of 1000 and the amount of data packets in the buffer of the current AP MLD is 50, then the Next SN in the context is 1000 and the buffer SN is 50. The current AP MLD will try to empty the remaining 50 data packets before the target AP MLD transmits the roaming association response frame, and the target AP MLD will continue to transmit data packets starting from SN 1050 after sending the roaming association response frame, as shown at step S516 of FIG. 5. If the next SN field is not included, the target AP MLD would not know from which data packet the subsequent data transmission starts. If the target AP MLD transmits the data packet with SN lower than 1050, duplicated transmission is caused. In addition, if the target AP MLD transmits data packets with SN starting from 1060, the data packets with SN between 1050 and 1060 are lost. Thus, with the context transfer, duplicated transmission can be avoided and packet loss can be mitigated.

In some embodiments of the present disclosure, the target AP MLD may transmit, to the non-AP MLD, data frames starting from a data frame with a first SN based on the next SN field and the buffer SN field. In some embodiments, the first SN may be based on a starting sequence number (SSN), and the SSN may be equal to a sum of the next SN and the amount of data frames indicated by the buffer SN field. In embodiments of in-order transmission, the target AP MLD may transmit data frames starting from the SSN. Alternatively, in embodiments of out-of-order transmission, the target AP MLD may transmit data frames starting from a data frame with a SN being not equal to the SSN. In some embodiments, if the sum of the next SN and the amount of data frames indicated by the buffer SN field does not exceed the upper limit for the SSN, the target AP MLD may transmit data frames starting from a data frame with a SN larger than the SSN in the case of out-of-order. In some embodiments, if the sum of the next SN and the amount of data frames indicated by the buffer SN field exceed the upper limit for the SSN, the SSN may equal to difference of the sum and the upper limit, for this cycle case, the target AP MLD may transmit data frames starting from a data frame with a SN subsequent to the SSN, rather than a larger number approaching the upper limit.

During the roaming association process, the current AP MLD may continue DL data transmission with the non-AP MLD until the target AP MLD respond the roaming association response. In some embodiments, step S514 may be perform before step S510 and/or step S512, that is, the current AP MLD may perform DL data transmission with the non-AP MLD before receiving the context transfer request frame or the context transfer response frame but after the transmission of the roaming association request frame, i.e., after step S506. In such situations, the next data frame and the amount of data frames to be transmitted by the current AP MLD are based on a starting point being ware of the roaming association request frame. In other words, the next data frame to be transmitted by the current AP MLD is the next data frame transmitted after the current AP MLD is aware of the roaming association request frame, and so do the amount of data frames.

After the non-AP MLD receives the roaming association response frame, due to the pre-transmission of the context, the non-AP MLD can directly exchange DL and UL data with the target AP MLD, as shown at step S516 of FIG. 5.

Since the roaming process occurs in a BA process, that is, the current AP MLD does not complete a BA process to receive the block acknowledgement response from the non-AP MLD. Instead, after roaming and completing the BA process, the non-AP MLD may respond to the target AP MLD with a block acknowledgement, as shown at step S520 of FIG. 5. In some embodiments, the block acknowledgement is a response to a BA request sent by the target AP MLD, as shown at step S518 of FIG. 5. In alternative embodiments, the block acknowledgement is not a response to a BA request and is transmitted by the non-AP MLD automatically after it completes the transmission of the data block.

For the BA process, there are two cases: (a) there are too much DL data buffered in the current AP MLD such that they cannot be transmitted before the roaming association response frame arrives the non-AP MLD, which causes some buffered data lost; and (b) packet loss occurs during the transmission of data buffered in the current AP MLD. In the conventional technologies, for packet loss, high layers that is higher than the AP, the high layers (for example, the distributed system) may retransmit all the data packets of the block.

In some embodiments of the present disclosure, for these two cases, in order to ensure the accuracy of this BA session. After receiving the BA, if there is packet loss, the target AP MLD sends a loss DL data request message to the current AP MLD to request the one or more lost packets to be retransmitted, as shown at step S522 of FIG. 5. Then, the current AP MLD transmits the one or more lost data packets to the target AP MLD through a DL data forwarding response, as shown at step S524 of FIG. 5, to help the target AP MLD retransmit the one or more lost packets to the non-AP MLD, as shown at step S526 of FIG. 5.

During the roaming association process, there is a further case that the size of DL data packets buffered in the current AP MLD is small, and the DL data transmission is completed in advance the transmission of the roaming association response frame. There will be a period of idle time without packet interaction, and thus delay of DL data transmission.

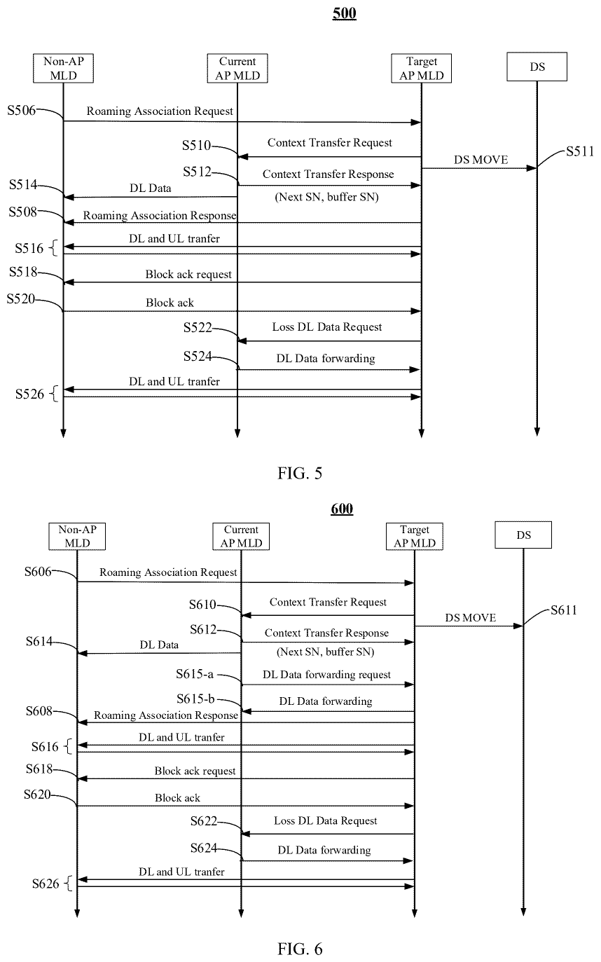

FIG. 6 shows an exemplary schematic diagram illustrating a further enhanced roaming process 600 in accordance with an embodiment of the present disclosure. As shown in FIG. 6, steps S606-S614, S616-S618 and S624-S626 in the enhanced roaming process 600 are substantially the same as steps S506-S514, S516-S518 and S524-S526 in the enhanced roaming process 500 described with reference to FIG. 5.

When coping with the advance completion of the DL data transmission, in order to ensure data continuity, the current AP MLD requests the data buffered in the target AP MLD through a DL data forwarding request message, as shown at step S615-a of FIG. 6. In response to the DL data forwarding request message, the target AP MLD may forward data packets buffered therein to the current AP MLD, as shown at step S615-b of FIG. 6, such that the current AP MLD can transmit the forwarded data packets to the non-AP MLD before the no-AP MLD receives the roaming association response frame.

In some embodiments, the amount of data packets to be forwarded to the current AP MLD may be a predefined amount indicated by the DL data forwarding request message, and the SSN of the DL data buffered in the target AP MLD is added with the amount. For example, if the SSN of the DL data buffered in the target AP MLD is 1000 and the amount of the forwarded data packets is 20, the SSN will be increased to 1020.

In other embodiments, the amount of data packets to be forwarded to the current AP MLD may be an amount predefined in the target AP MLD, which will forward the predefined amount of data packets to the current AP MLD upon receiving the DL data forwarding request message.

In further embodiments, the amount of data packets to be forwarded to the current AP MLD may be estimated by the target AP MLD, for example, the target AP MLD may estimate the time period before the feedback of a roaming response frame, and the current AP MLD may use the estimated time period to transfer DL data.

The enhanced roaming process 600 is further different from the enhanced roaming process 500 in steps S620-S622. The block acknowledgement transferring from the non-AP MLD to the target AP MLD, as shown at step S620 of FIG. 6, is associated with the data packets forwarded from the target AP MLD to the current AP MLD. Furthermore, the loss DL data request message sent to the current AP MLD, as shown at step S622 of FIG. 6, is to request one or more lost packets of the forwarded data packets. It should be appreciated by those skilled in the art that the steps S615-a and S615-b can be repeated several times as long as the roaming association response frame is not received by the non-AP MLD.

It should be appreciated by those skilled in the art that FIGS. 5-6 describe the enhanced roaming technologies above with reference to the MLO technology, and the enhanced roaming technologies apply to non-MLO technology, that is, the enhanced roaming technologies apply to the situations that the non-AP MLD and AP MLDs in FIGS. 5-6 are not multi-link devices.

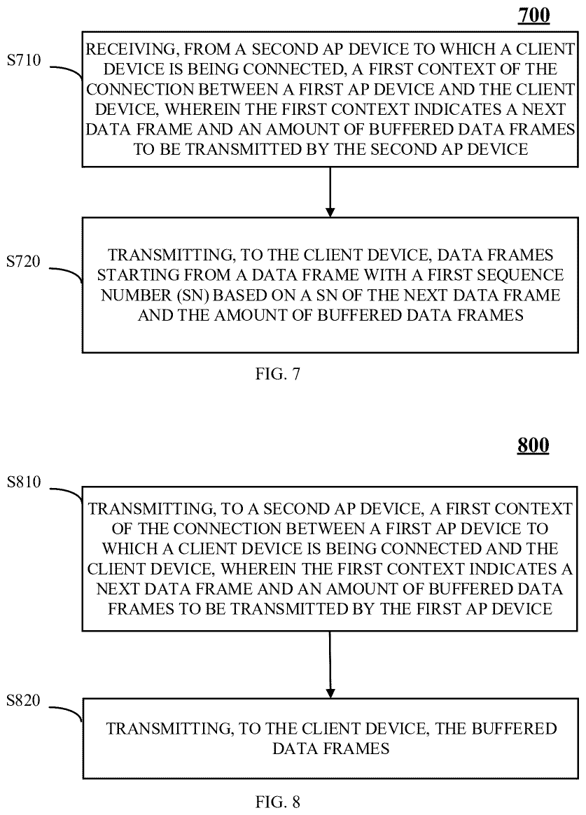

FIG. 7 shows a flowchart of a computer-implemented method 700 for wireless communication implemented at an access point (AP) device in accordance with an embodiment of the present disclosure.

The detailed description of method 700 can refer to the content described in the above with respect to FIGS. 1-6. For example, the method 700 can be executed in the architecture described with respect to FIGS. 1-6 and according to the interactions among a client device, a current AP device and a target AP device during roaming using the enhanced roaming mechanism as described with respect to FIGS. 1-6 (e.g., FIGS. 5-6). In addition, each step of method 700 can be performed by one or more processing units, such as central processing unit (CPU) of the target AP device.

With reference to FIG. 7, method 700 comprises steps S710-S720. At step S710, the first AP device, which may also be referred to as the target AP, the target AP device, or the target AP MLD, may receive, from a second AP device to which a client device is being connected, a first context of the connection between the second AP device and the client device. In accordance with embodiments of the present disclosure, the first context indicates a next data frame and an amount of buffered data frames to be transmitted by the second AP device. The second AP device in the embodiments of FIG. 7 may also be referred to as the current AP, the current AP device, or the current AP MLD. The client device in the embodiments of FIG. 7 may also be referred to as the STA, the non-AP device, or the non-AP MLD.

At step S720, the first AP device may transmit, to the client device, data frames starting from a data frame with a first sequence number (SN) based on a SN of the next data frame and the amount of buffered data frames.

In accordance with some embodiments, the first AP device may transmit, to the second AP device after receiving a second request for reassociating the client device with the first AP device, a first request for transferring the first context from the second AP device to the first AP device, wherein the first context is a response to the first request.

In accordance with some embodiments, the first context may include a subsequent transmission indication indicating the next data frame to be transmitted by the second AP device and a buffer indication indicating the amount of buffered data frames to be transmitted by the second AP device, and wherein the first SN is based on a starting sequence number (SSN), the SSN is equal to a sum of the SN of the next data frame and the amount of buffered data frames.

In accordance with some embodiments, the first AP device may transmit a second response to the second request, the second response indicating the reassociation between the client device and the first AP device is success, wherein the transmission of the data frames starting from the data frame with the first SN is after the transmission of the second response.

In accordance with some embodiments, the first AP device may receive a block acknowledgement (BA) associated with the buffered data frames; transmit, to the second AP device in response to failure of transmitting one or more data frames of the buffered data frames indicated by the BA, a third request for requesting one or more lost data frames; receive, from the second AP device, the one or more lost data frames; and transmit, to the client device, the one or more lost data frames.

In accordance with some embodiments, the first AP device may transmit, to the client device, a BA request associated with the buffered data frames, wherein the BA is received after transmitting the BA request.

In accordance with some embodiments, the first AP device may receive, from the second AP device, a fourth request for requesting data frames buffered in the first AP device; and in response to the fourth request, forward, to the second AP device, a certain amount of data frames buffered in the first AP device, wherein the amount of buffered data frames is added with the certain amount.

In accordance with some embodiments, the certain amount may be a predefined amount indicated by the fourth request, an amount predefined in the first AP device, or an amount estimated by the first AP device.

In accordance with some embodiments, the first AP device may receive a block acknowledgement (BA) associated with the forwarded certain amount of data frames; transmit, to the second AP device in response to failure of transmitting one or more data frames of the forwarded certain amount of data frames, a third request for requesting one or more lost data frames of the forwarded certain amount of data frames, wherein the failure of transmission is indicated by the BA; receive, from the second AP device, the one or more lost data frames; and transmit, to the client device, the one or more lost data frames.

In accordance with some embodiments, the first AP device may transmit, to a distributed system (DS) after transmitting the first request, a fifth request for notifying a mapping of the client device to the first AP device; and receiving and buffering data frames associated with the client device.

In accordance with some embodiments, the first AP device and the second AP device may be AP multi-link devices (MLDs) entity, and the client device may be a non-AP MLD entity.

In another aspect of the present disclosure, there is an access point (AP) device. The AP device may be a first AP device, which comprises one or more processors; a memory coupled to at least one of the processors; and a set of computer program instructions stored in the memory. When executed by at least one of the processors, the set of computer program instructions may cause the first AP device to perform the following operations: receiving a block acknowledgement (BA) associated with buffered data frames to be transmitted by a second AP device to which a client device is being connected; transmitting, to the second AP device in response to failure of transmitting one or more data frames of the buffered data frames indicated by the BA, a first request for requesting one or more lost data frames; receiving, from the second AP device, the one or more lost data frames; and transmitting, to the client device, the one or more lost data frames.

In accordance with a further aspect of the present disclosure, there is provided a method for wireless communication implemented at an access point (AP) device, which is a first AP device. The method may comprise receiving a block acknowledgement (BA) associated with buffered data frames to be transmitted by a second AP device to which a client device is being connected; transmitting, to the second AP device in response to failure of transmitting one or more data frames of the buffered data frames indicated by the BA, a first request for requesting one or more lost data frames; receiving, from the second AP device, the one or more lost data frames; and transmitting, to the client device, the one or more lost data frames.

In yet another aspect of the present disclosure, there is provided an access point (AP) device. The AP device may be a first AP device, which comprises one or more processors; a memory coupled to at least one of the processors; and a set of computer program instructions stored in the memory. When executed by at least one of the processors, the set of computer program instructions may cause the first AP device to perform the following operations: receiving, from a second AP device to which a client device is being connected, a first request for requesting data frames buffered in the first AP device; and in response to the first request, forwarding, to the second AP device, a certain amount of data frames buffered in the first AP device, wherein a starting sequence number (SSN) of data frames to be transmitted by the first AP device is added with the certain amount.

In accordance with still another aspect of the present disclosure, there is provided a method for wireless communication implemented at an access point (AP) device, which is a first AP device. The method may comprise receiving, from a second AP device to which a client device is being connected, a first request for requesting data frames buffered in the first AP device; and in response to the first request, forwarding, to the second AP device, a certain amount of data frames buffered in the first AP device, wherein a starting sequence number (SSN) of data frames to be transmitted by the first AP device is added with the certain amount.

FIG. 8 shows a flowchart of a computer-implemented method 800 for wireless communication implemented at an access point (AP) device to which a client device is being connected in accordance with an embodiment of the present disclosure.

The detailed description of method 800 can refer to the content described in the above with respect to FIGS. 1-6. For example, the method 800 can be executed in the architecture described with respect to FIGS. 1-6 and according to the interactions among a client device, a current AP device and a target AP device during roaming using the enhanced roaming mechanism as described with respect to FIGS. 1-6 (e.g., FIGS. 5-6). In addition, each step of method 700 can be performed by one or more processing units, such as central processing unit (CPU) of the current AP device.

With reference to FIG. 8, method 800 comprises steps S810-S820. At step S810, the first AP device to which a client device is being connected may transmit, to a second AP device, a first context of the connection between the first AP device and the client device. In accordance with embodiments of the present disclosure, the first context indicates a next data frame and an amount of buffered data frames to be transmitted by the first AP device. The first AP device in the embodiments of FIG. 8 may also be referred to as the current AP, the current AP device, or the current AP MLD. The second AP device in the embodiments of FIG. 8 may also be referred to as the target AP, the target AP device, or the target AP MLD. The client device in the embodiments of FIG. 8 may also be referred to as the STA, the non-AP device, or the non-AP MLD.

At step S820, the first AP device may transmit, to the client device, the buffered data frames.

In accordance with some embodiments, the first AP device may receive, from the second AP device, a first request for transferring the first context from the first AP device to the second AP device.

In accordance with some embodiments, the first context may include a subsequent transmission indication indicating the next data frame to be transmitted by the first AP device and a buffer indication indicating the amount of buffered data frames to be transmitted by the first AP device.

In accordance with some embodiments, the first AP device may acquire a roaming association request from the client device, the second AP device, or the distributed system. In accordance with some embodiments, the first AP device may acquire a roaming association response from the client device, the second AP device, or the distributed system.

In accordance with some embodiments, the first AP device may receive, from the second AP device, a third request for requesting one or more lost data frames of the buffered data frames; and transmit, to the second AP device, the one or more lost data frame.

In accordance with some embodiments, the first AP device may transmit, to the second AP device, a fourth request for requesting data frames buffered in the second AP device; and receive, from the second AP device, a certain amount of data frames buffered in the second AP device.

In accordance with some embodiments, the certain amount is a predefined amount indicated by the fourth request, is an amount predefined in the second AP device, or is an amount estimated by the second AP device.

In accordance with some embodiments, the first AP device and the second AP device may be AP multi-link devices (MLDs) entity, and the client device may be a non-AP MLD entity.

In another aspect of the present disclosure, there is provided an access point (AP) device. The AP device may be a first AP device to which a client device is being connected. The first AP device comprises one or more processors; a memory coupled to at least one of the processors; and a set of computer program instructions stored in the memory. When executed by at least one of the processors, the set of computer program instructions may cause the first AP device to perform the following operations: receiving, from a second AP device, a first request for requesting one or more lost data frames of the buffered data frames; and transmitting, to the second AP device, the one or more lost data frame.

In accordance with a further aspect of the present disclosure, there is provided a method for wireless communication implemented at an access point (AP) device, which is a first AP device to which a client device is being connected. The method may comprise receiving, from a second AP device, a first request for requesting one or more lost data frames of the buffered data frames; and transmitting, to the second AP device, the one or more lost data frame.

In yet another aspect of the present disclosure, there is provided an access point (AP) device. The AP device may be a first AP device to which a client device is being connected. The first AP device comprises one or more processors; a memory coupled to at least one of the processors; and a set of computer program instructions stored in the memory. When executed by at least one of the processors, the set of computer program instructions may cause the first AP device to perform the following operations: transmitting, to a second AP device, a first request for requesting data frames buffered in the second AP device; and receiving, from the second AP device, a certain amount of data frames buffered in the second AP device.

In accordance with still another aspect of the present disclosure, there is provided a method for wireless communication implemented at an access point (AP) device, which is a first AP device to which a client device is being connected. The method may comprise transmitting, to a second AP device, a first request for requesting data frames buffered in the second AP device; and receiving, from the second AP device, a certain amount of data frames buffered in the second AP device.

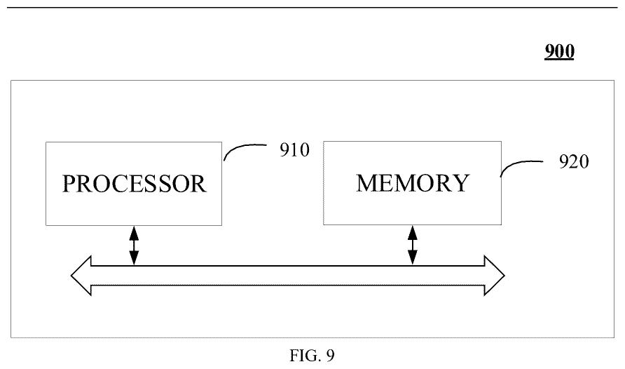

FIG. 9 is an exemplary block diagram illustrating a computing device in accordance with some embodiments of the present disclosure.

It should be noted that the computing device depicted in FIG. 9 can correspond to one or more of the current AP, the target AP, the current AP device, the target AP device, the current AP MLD, and the target AP MLD as described in FIGS. 1-8, and can be used to perform the actions involved in the roaming mechanism, for example, the method 800-900 as described above.

As shown in FIG. 9, the computing device 900 can comprise processor 910 and memory 920. The processor 910 is communicatively coupled with the memory and configured to perform the methods discussed above.

Examples of the processor 910 comprise microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure.

The processor 910 can execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on memory 920.

The memory 920 may be a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read-only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The memory 920 may reside in the processor 910, external to the processor 910, or distributed across multiple entities including the processor 910. The memory 920 may be embodied in a computer program product. By way of example, a computer program product may include a computer-readable medium in packaging materials. Those skilled in the art will recognize how to implement the described functionality presented throughout this disclosure depending on the particular application and the overall design constraints imposed on the overall system.

In addition, according to another embodiment of the present disclosure, a computer program product for wireless communication is disclosed. As an example, the computer program product comprises a non-transitory computer readable storage medium having program instructions embodied therewith, and the program instructions are executable by a processor. When executed, the program instructions cause the processor to perform one or more of the above-described procedures, and details are omitted herein for conciseness.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

Reference to an element in the singular is not intended to mean “one and only one” unless specifically so stated, but rather “one or more.” Similarly, reference to an element in the plural is not intended to mean “more than one” unless specifically so stated or being contradictory with the description elsewhere, but rather “one or more. ” Terms such as “if,” “when,” and “while” should be interpreted to mean “under the condition that” rather than implying an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C.

It should be noted that the flowcharts and block diagrams in the attached drawings illustrate the possible architectures, functions and operations of the methods and apparatuses according to various embodiments of the present application. In this regard, each block in the flowchart or block diagram may represent a module, a program segment, or a part of code, which contains at least one executable instruction for implementing a specified logical function. It should also be noted that in some alternative implementations, the functions noted in the blocks may occur in a different order than those noted in the drawings. For example, two blocks shown in succession may actually be executed substantially in parallel, and they may sometimes be executed in the reverse order, depending on the functions involved. It should also be noted that each block in the block diagrams and/or flowcharts, and combinations of blocks in the block diagrams and/or flowcharts, may be implemented by a dedicated hardware-based system that performs specified functions or operations, or by a combination of dedicated hardware and computer instructions The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

Throughout the description and claims of this specification, the word “comprise” and variations of the word, such as “comprising” and “comprises,” means “including but not limited to,” and is not intended to exclude, for example, other additives, components, integers or steps. “Exemplary” means “an example of and is not intended to convey an indication of a preferred or ideal embodiment. “Such as” is not used in a restrictive sense, but for explanatory purposes.

It should be noted that the above-mentioned examples illustrate rather than limit the invention, and that those skilled in the art will be able to design many alternative embodiments without departing from the scope of the appended claims. Any reference signs in the claims shall not be construed so as to limit their scope.

What is claimed is:

1. An access point (AP) device, the AP device being a first AP device, comprising:
one or more processors;
a memory coupled to at least one of the processors; and
a set of computer program instructions stored in the memory, which, when executed by at least one of the processors, cause the first AP device to perform operations of:
receiving, from a second AP device to which a client device is being connected, a first context of the connection between the second AP device and the client device, wherein the first context indicates a next data frame and an amount of buffered data frames to be transmitted by the second AP device; and
transmitting, to the client device, data frames starting from a data frame with a first sequence number (SN) based on a SN of the next data frame and the amount of buffered data frames.

2. The AP device of claim 1, wherein the set of computer program instructions, when executed by at least one of the processors, cause the first AP device to further perform an operation of:
transmitting, to the second AP device after receiving a second request for reassociating the client device with the first AP device, a first request for transferring the first context from the second AP device to the first AP device,
wherein the first context is a response to the first request.

3. The AP device of claim 1, wherein the first context includes a subsequent transmission indication indicating the next data frame to be transmitted by the second AP device and a buffer indication indicating the amount of buffered data frames to be transmitted by the second AP device, and
wherein the first SN is based on a starting sequence number (SSN), the SSN is equal to a sum of the SN of the next data frame and the amount of buffered data frames.

4. The AP device of claim 2, wherein the set of computer program instructions, when executed by at least one of the processors, cause the first AP device to further perform an operation of:
transmitting a second response to the second request, the second response indicating the reassociation between the client device and the first AP device is success,
wherein the transmission of the data frames starting from the data frame with the first SN is after the transmission of the second response.

5. The AP device of claim 1, wherein the set of computer program instructions stored in the memory, when executed by at least one of the processors, cause the first AP device to further perform operations of:
receiving a block acknowledgement (BA) associated with the buffered data frames;
transmitting, to the second AP device in response to failure of transmitting one or more data frames of the buffered data frames indicated by the BA, a third request for requesting one or more lost data frames;
receiving, from the second AP device, the one or more lost data frames; and
transmitting, to the client device, the one or more lost data frames.

6. The AP device of claim 5, wherein the set of computer program instructions, when executed by at least one of the processors, cause the first AP device to further perform an operation of:
transmitting, to the client device, a BA request associated with the buffered data frames,
wherein the BA is received after transmitting the BA request.

7. The AP device of claim 1, wherein the set of computer program instructions, when executed by at least one of the processors, cause the first AP device to further perform operations of:
receiving, from the second AP device, a fourth request for requesting data frames buffered in the first AP device; and
in response to the fourth request, forwarding, to the second AP device, a certain amount of data frames buffered in the first AP device,
wherein the amount of buffered data frames is added with the certain amount.

8. The AP device of claim 1, wherein the certain amount is a predefined amount indicated by the fourth request, an amount predefined in the first AP device, or an amount estimated by the first AP device.

9. The AP device of claim 7, wherein the set of computer program instructions, when executed by at least one of the processors, cause the first AP device to further perform operations of:
receiving a block acknowledgement (BA) associated with the forwarded certain amount of data frames;
transmitting, to the second AP device in response to failure of transmitting one or more data frames of the forwarded certain amount of data frames, a third request for requesting one or more lost data frames of the forwarded certain amount of data frames, wherein the failure of transmission is indicated by the BA;
receiving, from the second AP device, the one or more lost data frames; and
transmitting, to the client device, the one or more lost data frames.

10. The AP device of claim 1, wherein the set of computer program instructions, when executed by at least one of the processors, cause the first AP device to further perform operations of:
transmitting, to a distributed system (DS) after transmitting the first request, a fifth request for notifying a mapping of the client device to the first AP device; and
receiving and buffering data frames associated with the client device.

11. The AP device of claim 1, wherein the first AP device and the second AP device are AP multi-link devices (MLDs) entity, and the client device is a non-AP MLD entity.

12. An access point (AP) device, the AP device being a first AP device to which a client device is being connected, comprising:
one or more processors;
a memory coupled to at least one of the processors; and
a set of computer program instructions stored in the memory, which, when executed by at least one of the processors, cause the first AP device to perform operations of:
transmitting, to a second AP device, a first context of the connection between the first AP device and the client device, wherein the first context indicates a next data frame and an amount of buffered data frames to be transmitted by the first AP device; and
transmitting, to the client device, the buffered data frames.

13. The AP device of claim 12, wherein the set of computer program instructions, when executed by at least one of the processors, cause the first AP device to further perform an operation of:
receiving, from the second AP device, a first request for transferring the first context from the first AP device to the second AP device.

14. The AP device of claim 12, wherein the first context includes a subsequent transmission indication indicating the next data frame to be transmitted by the first AP device and a buffer indication indicating the amount of buffered data frames to be transmitted by the first AP device.

15. The AP device of claim 12, wherein the set of computer program instructions, when executed by at least one of the processors, cause the first AP device to further perform operations of:
receiving, from the second AP device, a third request for requesting one or more lost data frames of the buffered data frames; and
transmitting, to the second AP device, the one or more lost data frame.

16. The AP device of claim 12, wherein the set of computer program instructions, when executed by at least one of the processors, cause the first AP device to further perform operations of:
transmitting, to the second AP device, a fourth request for requesting data frames buffered in the second AP device; and
receiving, from the second AP device, a certain amount of data frames buffered in the second AP device.

17. The AP device of claim 16, wherein the certain amount is a predefined amount indicated by the fourth request, is an amount predefined in the second AP device, or is an amount estimated by the second AP device.

18. The AP device of claim 12, wherein the first AP device and the second AP device are AP multi-link devices (MLDs) entity, and the client device is a non-AP MLD entity.

19. A method for wireless communication implemented at an access point (AP) device, the AP device being a first AP device, the method comprising:
receiving, from a second AP device to which a client device is being connected, a first context of the connection between the second AP device and the client device, wherein the first context indicates a next data frame and an amount of buffered data frames to be transmitted by the second AP device; and
transmitting, to the client device, data frames starting from a data frame with a first sequence number (SN) based on a SN of the next data frame and the amount of buffered data frames.

20. A method for wireless communication implemented at an access point (AP) device, the AP device being a first AP device to which a client device is being connected, the method comprising:
transmitting, to a second AP device, a first context of the connection between the first AP device and the client device, wherein the first context indicates a next data frame and an amount of buffered data frames to be transmitted by the first AP device; and
transmitting, to the client device, the buffered data frames.
